(19) United States
(12) Patent Application Publication
(10) Pub. No.: US 2014/0166953 A1
(43) Pub. Date: Jun. 19, 2014

(54) HOIST LIMITING SYSTEMS AND METHODS

(71) Applicant: LONGYEAR TM, INC., South Jordan, UT (US)

(72) Inventors: CHRIS WRIGHT, Ontario (CA); STEFAN WREDE, Kirchhundem (DE); JOSHUA BYRON, South Jordan, UT (US)

(73) Assignee: LONGYEAR TM, INC., South Jordan, UT (US)

(21) Appl. No.: 13/718,026

(22) Filed: Dec. 18, 2012

(51) Int. Cl. B66D 1/56

(52) U.S. Cl. CPC B66D 1/56
USPC 254/270

(57) ABSTRACT

A hoist rotation limiting system for a hoist. A hoist drum has a grooved exterior surface configured to position a cable in a predetermined position relative to the ends and longitudinal axis of the hoist drum as the cable is wound onto or off of the hoist drum. Upon the cable being positioned in the predetermined position, the cable urges portions of a carrier weldment to contact a switch, thereby sending an electrical signal to stop rotation of a hoist motor.

### BACKGROUND

1. Field

This application relates generally to hoist limiting systems and methods and, more particularly, to systems and methods to limit a hoist from rotating beyond a desired rotation amount.

2. Background Technology

Hoist and/or winch systems can be used to lift or otherwise pull a rope or cable. For example, a trailing portion of the cable can be connected to a hoist drum of a hoist, and a leading portion of the cable can be connected to an item to be moved, such as, for example and without limitation, a drill rod from an exploratory drilling operation. A portion of the cable can be wound around the hoist drum a desired number of wraps to frictionally engage the drum and help maintain the connection between the cable and the hoist drum. The hoist drum can rotate in a first direction to lift or retrieve the item, and the hoist drum can rotate in a second direction to lower the item away from the hoist.

To save time necessary when lifting or lowering the item, the hoist drum can typically be rotated at a very high speed to quickly retrieve and return the item. When raising the item, if the hoist drum over rotates, the item can contact a pulley or other equipment thereby potentially damaging the item and/or the other equipment. Similarly, when lowering the item, if the hoist drum over rotates, the cable can become unwound from the hoist drum. This can reduce the number of wraps of the cable around the hoist drum to a level below the desired number of wraps.

Accordingly, there is a need in the pertinent art for retrieval systems that limit the rotation of the hoist drum to a desired rotation amount in both the first and second rotation directions.

### SUMMARY

Described herein is a hoist limiting system to prevent over rotation of a hoist or winch. The hoist limiting system can comprise at least one of a hoist drum, a carrier weldment and at least one switch.

In one aspect, the hoist drum can be configured for selective rotation about a drum rotation axis in a first direction and an opposed, second direction. In another aspect, a groove can be defined in at least a portion of an exterior surface of the drum in a helical pattern such that the groove is a continuous groove extending from a first end of the hoist drum towards a second end of the hoist drum. The groove can be sized to correspond to a diameter of a cable attached to the hoist drum. In use, as the drum rotates, the groove of the drum can urge the cable to a desired position around the drum. As can be appreciated, because the hoist drum diameter is known and because the groove of the hoist drum urges the cable to the desired position, the length of cable wound onto or off of the hoist drum can easily be calculated. Further, because the hoist drum diameter is known and because the groove of the hoist drum urges the cable to the desired position, each groove location can correspond to a predetermined length of cable. For example, if a portion of the cable first contacts the groove of the drum at a predetermined location between the first and second ends of the hoist drum, the length of cable required to be wound onto or off of the hoist drum for the cable to contact that groove location can be determined.

In one aspect, the carrier weldment can be positioned adjacent the hoist drum and can comprise a mounting plate, at least one cable finger and at least one trigger contacting member. In this aspect, the mounting plate can be slidably attached to the hoist such that the mounting plate can slide in a direction substantially parallel to the hoist drum rotation axis. The at least one cable finger and at the least one trigger contacting member can be attached to and extend from the mounting plate.

The at least one switch can be positioned between the hoist drum and at least a portion of the carrier weldment, and can be electrically coupled to the hoist (for example, a motor of the hoist), to stop or start rotation of the hoist drum.

In use, rotation of the grooved hoist drum can urge the cable towards the first or second end of the hoist drum. The at least one cable finger can be positioned relative to the first and/or second ends so that the cable contacts that at least one cable finger when a desired length of cable has been wound onto, or unwound from, the hoist drum. This contact between the cable and the at least one cable finger can slide the mounting plate and the at least one trigger contacting member until the at least one contacting member actuates the at least one switch. Upon actuation, the at least one switch can send a signal to the hoist motor, thereby stopping rotation of the hoist.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a side elevational view of a first exemplary hoist limiting system as described herein.

FIG. 2 is an exploded perspective view of the hoist limiting system of FIG. 1.

FIG. 3 is an assembled perspective view of the hoist limiting system of FIG. 1.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a hoist” can include two or more such hoists unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

Reference will be made herein to a hoist for use with a mainline retrieval system. However, it is contemplated that the hoist limiting systems described here can be used with a hoist or winch in any application such as, for example, construction hoists, elevator hoists, automotive winches, and the like. Further, it is understood that the hoist limiting system of the present application can be used in any other instances in which a hoist or winch is required, such as for example and without limitation, a haul hoist of a drilling system or other non-drilling systems in which a hoist is used.

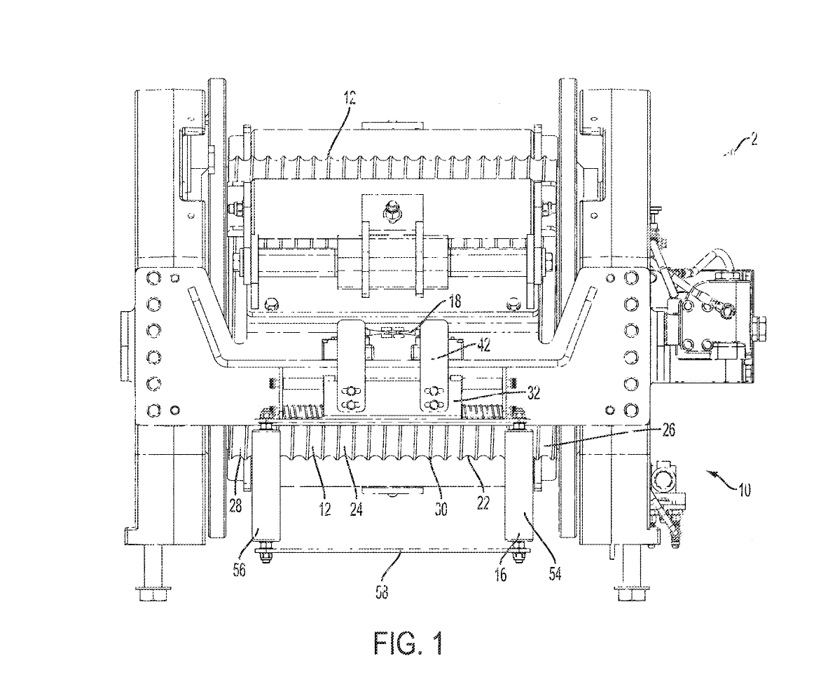

Referring now to FIG. 1, in one aspect, the hoist limiting system 10 for a hoist 2 can comprise at least one of a hoist drum 12, a carrier weldment 14 and at least one switch 18. As described more fully below, rotation of the hoist drum can cause a cable attached to the drum to contact a portion of the carrier weldment, thereby moving the carrier weldment 14 to actuate the at least one switch. The at least one switch can be electrically coupled to the hoist (for example and without limitation, a motor or processor of the hoist), to stop or start rotation of the hoist. As can be appreciated, the hoist limiting system can be a kit configured for retrofitting a conventional hoist that lacks a hoist limiting system. Alternatively, the hoist limiting system 10 can be a portion of a hoist 2 having an integrated hoist limiting system.

The hoist drum 12 is a drum configured for selective rotation about a drum rotation axis (i.e., the longitudinal axis of the drum). In one aspect, the hoist drum can rotate about the drum rotation axis in a first direction and an opposed, second direction. In use, a cable 20, wire, rope and the like (referred to hereinafter only as a “cable” for convenience and clarity) can be attached to the hoist drum 12 so that rotation in the first direction winds a portion of the cable onto the hoist drum, and rotation in the second direction unwinds a portion of the cable 20 from the hoist drum. In another aspect, the hoist drum 12 can have a drum diameter.

In one aspect, an exterior surface 22 of the hoist drum 12 can define a groove 24. In another aspect, the groove can be defined in a helical pattern on the exterior surface of the hoist drum such that the groove is a continuous groove extending from a first end 26 of the hoist drum to a second end 28 of the hoist drum 12. In yet another aspect, the groove can have a groove diameter sized to correspond to a diameter of the cable 20. For example, the groove diameter can be substantially equal to or slightly larger than the diameter of the cable so that the cable can be positioned in the groove. In a further aspect, at least a portion of the groove 24 can be positioned at an acute angle relative to the drum rotation axis of the hoist drum 12. In this aspect, as the hoist drum rotates in the first direction, the cable can be wound onto the hoist drum and can be positioned in the groove from the first end of the hoist drum towards the second end. Similarly, as the hoist drum rotates in the second direction, the cable can be unwound from the hoist drum 12 from the second end 28 of the hoist drum towards the first end 26.

The groove 24 can comprise at least one groove sidewall 30 configured to separate one course of the groove from an adjacent course of the groove. In one aspect, the groove sidewall can have a sidewall height corresponding to the diameter of the cable 20. For example, the groove sidewall can have a sidewall height of about 10%, about 20%, about 25%, about 30%, about 33%, about 40%, about 50%, about 60%, about 67%, about 70%, about 75%, about 80%, about 90%, or about 100% of the diameter of the cable. In another aspect, the groove sidewall 30 can be positioned at an acute angle relative to the drum rotation axis of the hoist drum 12. In use, as the hoist drum rotates, the groove sidewall can urge at least a portion of the cable into the groove.

In one aspect, the groove 24 and/or the groove sidewall 30 can position the cable 20 around the hoist drum 12 in an orderly and/or repeatable manner. For example, the groove and/or the groove sidewall can position a portion of the cable around the hoist drum in a first layer of cable that is positioned in the groove. The sidewall can space the wraps of cable 20 from each other so that a second layer of cable can be positioned in wraps formed on top of the first layer in a repeatable manner. This can continue until the desired length of cable has been positioned on the hoist drum 12. That is, the cable can be wound onto the hoist drum in the same manner each time so that the same portion of cable 20 is positioned in the same location on the hoist drum every time it is wound onto the hoist drum. Similarly, the cable can be unwound from the hoist drum 12 in the same manner each time so that the same portion of cable is positioned in the same location on the hoist drum every time it is unwound from the hoist drum 12. In another example, the groove and/or the groove sidewall can position a portion of the cable around the hoist drum in a first layer of cable that is positioned in the groove, such that a second layer of cable will not be positioned in wraps formed on top of the first layer.

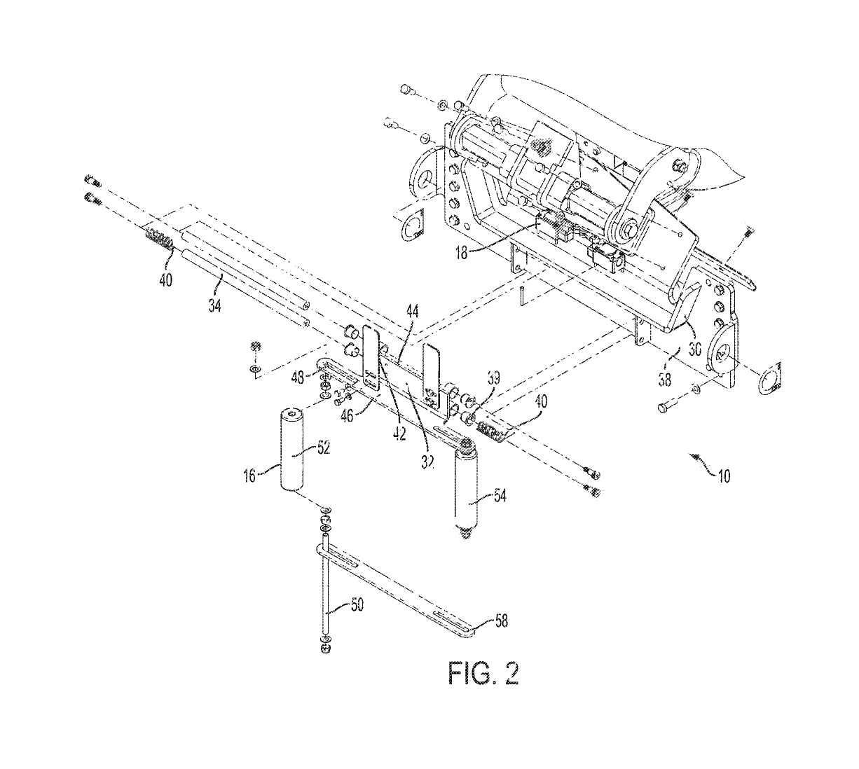

The carrier weldment 14 can be positioned adjacent the hoist drum 12 and can comprise a mounting plate 32 and at least one axial rod 34, as illustrated in FIG. 2. In one aspect, the carrier weldment further comprises a mounting bracket 36. The at least one axial rod can be securedly attached adjacent the hoist, by for example, attaching the at least one axial rod 34 to a frame 38 of the hoist 2. In another example, the mounting bracket 36 can be securedly attached to the frame of the hoist, and the at least one axial rod 34 can be securedly attached to the mounting bracket. In another aspect, the at least one axial rod can be positioned adjacent the hoist drum 12 such that a rod longitudinal axis is substantially parallel to the drum rotation axis of the hoist drum.

At least a portion of the mounting plate 32 can be slidably attached to the at least one axial rod 34 so that the mounting plate can slide along the rod axis. For example, at least a portion of the mounting plate can surround at least a portion of the axial rod so that the mounting plate is free to slide along the rod axis. In one aspect, at least one bushing 39 can be attached to the mounting plate. In this aspect, the at least one axial rod can be inserted through the at least one bushing to guide the axial rod 34 along the rod axis. In use then, the mounting plate 32 can be configured for linear movement substantially parallel to the drum rotation axis of the hoist drum 12.

In another aspect, the carrier weldment 14 can further comprise a means for centering at least a portion of the mounting plate 32 relative to a center line of the hoist drum 12. For example, the carrier weldment can comprise a biasing means 40 (such as, for example and without limitation, a spring) positioned on opposed ends of the at least one axial rod 34. Each biasing means can exert approximately the same force on the mounting plate so that, in the absence of external forces, the mounting plate 32 can be approximately centered relative to the center line of the hoist drum 12. Thus, if the biasing means comprises a pair of compressive springs, the springs can be approximately the same length, and can each exert approximately the same force on the mounting plate.

In one aspect, the carrier weldment 14 can further comprise at least one trigger contacting member 42 attached to and extending from the mounting plate 32. For example, the at least one trigger contacting member can be an arm, plate or the like configured to contact the at least one switch 18 when the mounting plate is in a predetermined position. In another aspect, the at least one trigger contacting member 42 can be positioned on the mounting plate such that when the mounting plate of the carrier weldment is in a predetermined position, the at least one trigger contacting member contacts the at least one switch 18. In yet another aspect, the at least one trigger contacting member 42 can extend away from a first side 44 of the mounting plate 32 a predetermined distance. For example, the at least one trigger contacting member can be positioned such that a longitudinal axis of the trigger contacting member is substantially normal to the rod axis of the at least one axial rod 34. In a further aspect, the at least one trigger contacting member can be adjustably, securedly attachable to the carrier weldment 14. That is, the at least one trigger contacting member 42 can be selectively positioned by a user relative to the mounting plate, so that the mounting plate 32 is in a predetermined position when the at least one trigger contacting member 42 contacts the at least one switch. For example, the at least one trigger contacting member can define an adjustment slot so that the at least one trigger contacting member 42 can selectively be positioned relative to the mounting plate 32 by a user.

According to one aspect, the carrier weldment 14 can further comprise at least one cable finger 16 attached to and extending therefrom. In one aspect, the at least one cable finger can be positioned such that a longitudinal axis of the finger is substantially normal to the rod axis of the at least one axial rod 34. In another aspect, the at least one cable finger can extend from a second side 46 of the mounting plate 32 a predetermined distance. As can be appreciated, the first side 44 of the mounting plate can be opposed to the second side, such that the at least one trigger contacting member 42 and the at least one cable finger extend generally away from each other. In a further aspect, at least one slot 48 can be defined in a portion of the mounting plate 32. In this aspect, the slot can allow the position of the cable finger 16 to selectively be adjusted relative to the mounting plate as desired by a user. For example, a rod 50, bolt, screw, pin and the like could extend through the slot and attach to the at least one cable finger. A user could move the at least one cable finger 16 relative to the slot 48 to a desired positioned, after which the rod, bolt, screw, pin and the like could be tightened to securedly attach and maintain the at least one cable finger in the desired position.

In another aspect, the at least one cable finger 16 can be a substantially cylindrical roller 52. In this aspect, the roller can be configured for selective rotation about a roller rotation axis. In a further aspect, the roller rotation axis can be substantially normal to the drum rotation axis of the hoist drum 12.

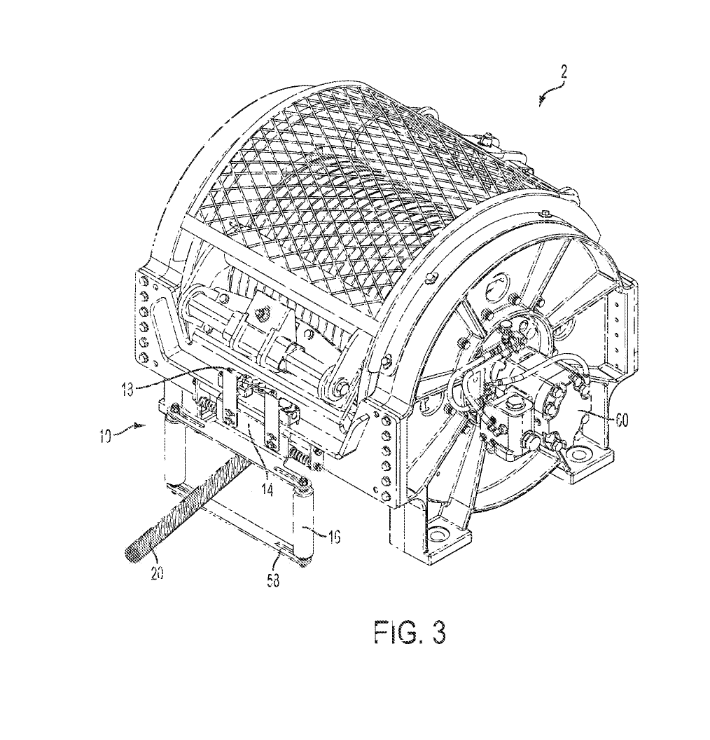

As illustrated in the figures, the at least one cable finger 16 can comprise two cable fingers. In one aspect, a first cable finger 54 can be spaced from a second cable finger 56 a predetermined distance. In another aspect, the first cable finger can be positioned adjacent the first end 26 of the hoist drum 12, and the second cable finger can be positioned adjacent the second end 28 of the hoist drum. In another aspect, a bar 58 can couple the free ends of the ends of the first and second cable fingers (i.e., the ends of the first and second cable fingers opposed to the mounting plate 32). In this aspect, as can be appreciated, portions of the mounting plate, the first and second cable fingers 54, 56 and the bar 58 can form an enclosure through which the cable can be threaded, as illustrated in FIG. 3.

The at least one switch 18 can be a toggle switch configured to send an electrical signal upon actuation by the at least one trigger contacting member 42. Thus, in one aspect, the at least one switch can be positioned adjacent to the at least one trigger contacting member so that, upon movement of the at least one trigger contacting member 42 in a desired direction, the at least one switch sends an electrical signal to start, speed up, slow down, reverse and/or stop the hoist motor. In another aspect, the at least one switch 18 can comprise two switches. In this aspect, a first switch can be positioned adjacent to the at least one trigger contacting member so that, upon movement of the at least one trigger contacting member 42 in a first direction, the at least one switch sends a first electrical signal to the hoist motor and a second switch can be positioned adjacent to the at least one trigger contacting member so that, upon movement of the at least one trigger contacting member in a second direction, the at least one switch 18 sends a second, different electrical signal to the hoist motor. In still another aspect, the at least one switch can be a dual switch configured to send a first electrical signal when contacted from a first side, and a second electrical signal when contacted from a second side. In this aspect, for example, the dual switch can send a first electrical signal upon actuation by a first trigger contacting member and a second electrical signal upon actuation by a second trigger contacting member.

To assemble the hoist limiting system 10, the mounting bracket 36 can be securedly attached to the frame 38 of the hoist 2, and the at least one axial rod 34 can be securedly attached to the mounting bracket. Alternatively, in one aspect, the at least one axial rod 34 can be securedly attached to the frame 38 of the hoist adjacent to the hoist drum 12.

The at least one axial rod 34 can be positioned such that a longitudinal axis of the axial rod is substantially parallel to the drum rotational axis of the hoist drum 12. The mounting plate 32 can be slidably attached to the at least one axial rod. In one aspect, the mounting plate can be slidably attached to the at least one axial rod between the biasing means 40. For example, the mounting plate can be slidably positioned on the axial rod, and the biasing means can urge the mounting plate to a center, neutral position.

The at least one cable finger 16 can be securedly attached to the mounting plate 32 such that the longitudinal axis of the at least one cable finger is substantially normal to the drum rotational axis of the hoist drum 12. In one aspect, the at least one cable finger can extend away from the second side 46 of the mounting plate. As will be discussed more fully below, the at least one cable finger can be positioned on the mounting plate in a predetermined position to correspond to a desired cable length. Similarly, the at least one trigger contacting member 42 can be securedly attached to and extend from the mounting plate 32. For example, the least one trigger contacting member can extend away from the first side 44 of the mounting plate.

The at least one switch 18 can be securedly attached to the frame 38 of the hoist 2 or to the mounting bracket 36 at a desired position. In one aspect, at least a portion of the at least one switch can be positioned between the hoist drum 12 and the mounting plate 32. In this aspect, as the mounting plate slides along the at least one axial rod 34, portions of the mounting plate and/or the at least one trigger contacting member 42 can contact the switch when the mounting plate and/or the least one trigger contacting member are in the desired position. In another aspect, the at least one switch 18 can be electrically coupled to the motor of the hoist 2. For example, the at least one switch can be coupled to a means for controlling the motor of the hoist, such as a motor controller, a processor and the like.

In use, a first end of the cable 20 can be attached to the hoist drum 12. As can be appreciated, upon rotation of the hoist drum about the rotation axis in a first direction, the cable can be at least partially wound around the hoist drum. As the hoist drum rotates, the cable can be positioned in the groove 24 by the groove and/or the groove sidewall 30. For example, the cable and the grove of the hoist drum can be sized so that at least a portion of the cable 20 can be positioned in the groove. Because the hoist drum has a drum diameter, each revolution of the hoist drum can correspond to the known length of cable being wound onto or unwound from the hoist drum.

In one aspect, because the groove 24 can be a helical groove extending from the first end 26 of the hoist drum 12 towards the second end 28 of the hoist drum, the cable 20 can be at least partially wound around the hoist drum from the first end towards the second end of the hoist drum 12. That is, as the cable is wound onto the hoist drum, the cable 20 can be wound onto the drum at a changing position on the drum face. In one aspect, the position of cable 20 being wound onto the hoist drum changes relative to the first and second ends of the drum as the drum rotates. For example, when the hoist drum 12 rotates about the rotation axis in the first direction, the cable can be positioned in the groove 24 such that each successive portion of the cable is positioned closer to the second end 28 of the hoist drum that the preceding portion. Similarly, when the hoist drum rotates about the rotation axis in the second direction, the cable can be positioned in the groove such that each successive portion of the cable is positioned closer to the first end 26 of the hoist drum 12 that the preceding portion.

In another aspect, the groove 24 and/or the groove sidewall 30 can position the cable 20 around the hoist drum 12 in an orderly and/or repeatable manner. That is, the cable can be wound onto the hoist drum in the same manner each time so that the same portion of cable is positioned in the same location on the hoist drum every time it is wound onto the hoist drum 12. Because of this, the position of a portion of the cable 20 on the hoist drum relative to the ends of the hoist drum and the longitudinal axis of the hoist drum can correspond to a cable length. That is, the positioning of the cable on the hoist drum can be correlated to a length of cable 20 wound onto the hoist drum and a length of cable unwound from the hoist drum for every position of cable on the hoist drum.

As the hoist drum 12 rotates and the position of the cable 20 being wound onto the drum changes, a portion of the cable can contact the at least one cable finger 16. As the drum continues to rotate, a portion of the cable can exert a sufficient force to overcome the force exerted on the mounting plate 32 by the biasing means 40, and the at least one cable finger and the mounting plate can slide along the at least one axial rod 34 towards the first end 26 or the second end 28 of the hoist drum (depending on the direction of rotation of the hoist drum). Because the at least one trigger contacting member 42 can be attached to and extend from the mounting plate 32, the sliding movement of the at least one cable finger and mounting plate can slide the at least one trigger contacting member into contact with the at least one switch 18, thereby actuating the switch. Upon actuation of the switch, the switch 18 can send an electrical signal to cause the motor of the hoist 2 to stop or otherwise alter the rotation speed and/or direction of the hoist drum 12. For example, upon actuation of the switch, the switch can send an electrical signal to cause the motor of the hoist to stop, speed up, slow down, or reverse the rotation of the hoist drum as desired by the user.

In one aspect, because the hoist drum 12 has a drum diameter, the position of the at least one cable finger 16 can be selected to correspond to a desired length of cable 20. For example, if the drum diameter is such that the drum face has a perimeter distance of one foot, and a user of the hoist 2 wants to stop the hoist after five feet of cable has been wound onto the hoist drum 12, the at least one cable finger 16 can be positioned such that after about five revolutions of the hoist drum, portions of the cable 20 will contact the at least one cable finger, urging the cable finger 16, the mounting plate 32 and the at least one trigger contacting member 42 to slide so that the trigger contacting member contacts the switch 18, thereby stopping the hoist drum.

In another example, to stop rotation of the hoist drum 12 with a desired amount of cable extending from the hoist drum, a user can rotate the hoist drum until the desired amount of cable has been wound onto or off of the drum. The position of the at least one cable finger 16 and/or the at least one trigger contacting member 42 can be set relative to the ends and/or the longitudinal axis of the hoist drum 12 so that the at least one cable finger is contacting the cable 20, and the at least one trigger contacting member 42 is contacting the switch 18. Then, in subsequent winding or unwinding operations, because the cable is positioned on the hoist drum 12 in a repeatable manner, every time the desired amount of cable 20 extends from the hoist drum, the cable will urge the at least one cable finger 16, the mounting plate 32 and the at least one trigger contacting member 42 to slide so that the trigger contacting member contacts the switch, thereby stopping the hoist drum.

In another aspect, if the at least one cable finger 16 comprises two cable fingers, the cable fingers can be positioned around the cable such that the first cable finger 54 is positioned between the cable 20 and the first end 26 of the hoist drum, and the second cable finger 56 is positioned between the cable and the second end 28 of the hoist drum. In this aspect, the rotation of the hoist drum 12 in the first direction can cause the cable 20 to contact the first cable finger and slide the first cable finger 54 towards the first end of the drum until the at least one trigger contacting member 42 contacts the at least one switch 18. Similarly, the rotation of the hoist drum 12 in the second direction can cause the cable to contact the second cable finger 56 and slide the second cable finger towards the second end of the drum until the at least one contacting member contacts the at least one switch.

If the at least one switch 18 comprises two switches, the first switch can send a first electrical signal upon actuation by a trigger contacting member 42 moving in the first direction, and the second switch can send a second electrical signal upon actuation by a trigger contacting member moving in the second direction. If the at least one switch is a dual switch, the at least one switch 18 can send a first electrical signal upon actuation by a trigger contacting member moving 42 in the first direction and a second electrical signal upon actuation by a trigger contacting member moving in the second direction.

The methods and systems described above require no particular component or function. Thus, any described component or function—despite its advantages—is optional. Also, some or all of the described components and functions described above can be used in connection with any number of other suitable components and functions.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

1. A hoist limiting system for a hoist having a hoist motor, the hoist limiting system comprising:
a hoist drum coupled to the hoist motor, wherein the hoist drum is configured for selective rotation about a rotation axis, wherein an exterior surface of the hoist drum defines a groove, and wherein the hoist drum has a first end and a second end;
a cable configured to be positioned therein the, groove of the hoist drum, wherein the cable is at least partially wound around the hoist drum such that, upon rotation of the hoist drum about the rotation axis in a first direction, the cable is further wound around the hoist drum in a predetermined direction relative to the first and second ends of the hoist drum;
a carrier weldment positioned adjacent the hoist drum and comprising:
a mounting plate slidably attached to the hoist,
at least one trigger contacting member extending away from a first side of the mounting plate a predetermined distance; and
at least one cable contacting finger attached to and extending away from a second, opposed side of the mounting plate;
a mounting bracket fixed to a central portion of a frame of the hoist; and
at least one switch positioned on a central portion of the mounting bracket between the hoist drum and the mounting plate, the at least one switch being electrically coupled to the hoist motor,
wherein the at least one switch is located interior to the at least one trigger contacting member, and
wherein after the cable is wound around the hoist drum a predetermined distance, a portion of the cable contacts the at least one cable contacting finger and urges the at least one cable contacting finger, the mounting pate, and the at least one trigger contacting member to slide towards an end of the hoist drum, wherein upon sliding a predetermined distance, the at least one trigger contacting member contacts and actuates the at least one switch, and wherein upon actuation, the at least one switch sends a signal to the hoist motor to alter rotation of the hoist motor arid hoist drum.

2. The hoist limiting system of claim 1, wherein the groove is a continuous, helical groove extending from the first end of the hoist drum to the second end.

3. The hoist limiting system of claim 1, wherein a longitudinal axis of the at least one cable contacting finger is substantially normal to the rotation axis of the hoist drum.

4. The hoist limiting system of claim 3, wherein a longitudinal axis of the at least one trigger contacting member is substantially normal to the rotation axis of the hoist drum.

5. The hoist limiting system of claim 1, wherein the carrier weldment further comprises at least one rod attachable to the hoist, and wherein a longitudinal axis of the at least one rod is substantially parallel to the drum rotation axis of the hoist drum.

6. The hoist limiting system of claim 5, wherein at least a portion of the mounting plate is slidably attached to the at least one axial rod so that the mounting plate can slide in a direction substantially parallel to the rod longitudinal axis.

7. The hoist limiting system of claim 6, farther comprising a means for centering at least a portion of the mounting plate relative to a center of the hoist drum.

8. The heist limiting system of claim 7, wherein the means for centering comprises a spring positioned on opposed ends of the at least one axial rod.

9. The hoist limiting system of claim 1, wherein the at least one switch comprises at least a first switch and a second switch, wherein the first switch sends a first electrical signal to the hoist motor upon actuation by the trigger contacting member moving in first direction, and the second switch sends a second electrical signal upon actuation by a trigger contacting member moving in a second direction.

10. The hoist limiting system of claim 1, further comprising means for positioning at least a portion of the cable around the hoist drum in a repeatable manner.

11. The hoist limiting system of claim 1, wherein the signal to alter rotation of the hoist motor and hoist drum comprises a signal to stop the rotation of the hoist drum.

12. The hoist limiting system of claim 1, wherein the signal to alter rotation of the hoist motor and hoist drum comprises a signal to slow down rotation speed of the hoist drum.

13. The hoist limiting system of claim 1, wherein the signal to alter rotation of the hoist motor and hoist drum comprises a signal to reverse the rotation direction of the hoist drum.

14. A method for limiting the rotation of a hoist beyond a desired amount, the method comprising:
providing a cable at least partially wound around a hoist drum of a hoist, wherein an exterior surface of the hoist drum defines a groove configured to receive a portion of the cable therein;
slidably attaching a mounting plate to a mounting bracket attached to a frame of the hoist, wherein at least one trigger contacting member extends away from a first side of the mounting plate a predetermined distance and wherein at least one cable contacting finger extends away from a second, opposed side of the mounting plate;
providing at least one switch positioned on a central portion of the mounting bracket between the hoist drum and the mounting plate, the at least one switch being electrically coupled to the hoist motor,
selectively rotating the hoist drum in a first direction about a rotation axis such that the cable is wound onto the hoist drum and a portion of the cable contacts the at least one cable contacting member, wherein upon contacting the at least one cable contacting member, the portion of the cable urges the at least one cable contacting finger, the mounting plate, and the at least one trigger contacting member to slide towards an end of the hoist drum, wherein upon sliding a predetermined distance, the at least one trigger contacting member contacts and actuates the at least cite switch, and wherein upon actuation, the at least one switch sends a signal to the hoist motor to stop rotation of the hoist motor and hoist drum.

15. A hoist limiting system for a hoist having a hoist motor, the hoist limiting system comprising:
a hoist drum coupled to the hoist motor, wherein the hoist drum is configured for selective rotation about a rotation axis wherein the hoist drum has a first end and a second end;
a cable configured to be positioned around the hoist drum wherein be cable is at least partially wound around the hoist drum such that, upon rotation of the hoist drum about the rotation axis in a first direction, the cable is further wound around the hoist drum in a predetermined direction relative to the first and second ends of the hoist drum;
a carrier weldment slidably positioned adjacent the hoist drum and comprising a mounting plate slidably attached to the hoist;
a mounting bracket fixed to a central portion of a frame of the hoist; and
at least one switch positioned on a central portion of the mounting bracket between the hoist drum and the mounting plate, the at least one switch being electrically coupled to the hoist motor, and
means for positioning at least a portion of the cable around the hoist drum in a repeatable manner.
wherein the at least one switch is located interior to the at least one trigger contacting member, and
wherein upon the cable being wound around the hoist drum a predetermined distance, a portion of the cable contacts the carrier weldment and urges the carrier weldment into contact with the at one switch, and wherein contact with the carrier weldment actuates the at least one switch to send a signal to the hoist motor to alter rotation of the hoist motor and hoist drum.

16. The hoist limiting system of claim 15, further comprising a means for centering at least a portion oft he carrier weldment relative to a center of the hoist drum.

17. The hoist limiting system of claim 16, wherein the means for positioning at least a portion of the cable around the hoist drum in a repeatable manner comprises a groove defined in an exterior surface of the hoist drum.

18. The hoist limiting system of claim 17, wherein the groove is a continuous, helical groove extending from the first end of the hoist drum to the second end.
